(19) United States
(12) Patent Application Publication
(10) Pub. No.: US 2023/0055894 A1
(43) Pub. Date: Feb. 23, 2023

(54) TEACHING LITERARY CONCEPTS THROUGH MEDIA

(71) Applicant: Words Liive, Inc., Washington, DC (US)

(72) Inventor: Gilbert Newman Perkins, Alexandria, VA (US)

(21) Appl. No.: 17/408,308

(22) Filed: Aug. 20, 2021

(51) Int. Cl. G09B 17/00; G09B 5/06; G09B 7/02; G09B 19/00

(52) U.S. Cl. CPC G09B 17/006; G09B 5/065; G09B 7/02; G09B 19/00

(57) ABSTRACT

Methods, systems, and storage media for teaching literary concepts are disclosed. Exemplary implementations may: generate a first list comprising a plurality of literary concepts; receive a first selection comprising at least one literary concept of the plurality of literary concepts; generate a second list comprising a plurality of media based on the first selection; receive a second selection comprising at least one media of the plurality of media; and generate a lesson plan comprising the at least one media based on the second selection.

### TECHNICAL FIELD

The present disclosure generally relates to teaching literary concepts, and more particularly to teaching literary concepts through media.

### BACKGROUND

In the previous US standard, literacy was considered sufficient with the ability to read a simple sentence. The present US standard for literacy, however, is based on the ability to use printed and written information to function in society, to achieve one's goals, and to develop one's knowledge and potential. The United States Department of Education assesses literacy in youth through its National Assessment of Educational Progress (NAEP) reading assessment. The NAEP assessment is given every two years to students at grades 4 and 8, and approximately every four years at grade 12. The assessment measures reading comprehension by asking students to read selected grade-appropriate materials and answer questions based on what they have read. The results present a broad view of students' reading knowledge, skills, and performance over time.

### BRIEF SUMMARY

The subject disclosure provides for systems and methods for teaching literary concepts. In exemplary implementations, a user is allowed to select a literary concept. A plurality of anchor texts and a plurality of media that illustrate the literary concept are presented to the user for selection. The selected literary concept (e.g., pluralism), anchor text (e.g., a classic book), and media (e.g., a song by a contemporary recording artist) are then used to automatically generate a multimedia lesson plan for teaching the literary concept.

One aspect of the present disclosure relates to a method for teaching literary concepts. The method may include generating a first list including a plurality of literary concepts. The method may include receiving a first selection including at least one literary concept of the plurality of literary concepts. The method may include generating a second list including a plurality of media based on the first selection. Content of each media may include at least one example of the at least one literary concept. The method may include receiving a second selection including at least one media of the plurality of media. The method may include generating a lesson plan including the at least one media based on the second selection.

Another aspect of the present disclosure relates to a system configured for teaching literary concepts. The system may include one or more hardware processors configured by machine-readable instructions. The processor(s) may be configured to generate a first list including a plurality of literary concepts. The processor(s) may be configured to receive a first selection including at least one literary concept of the plurality of literary concepts. The processor(s) may be configured to generate a second list including a plurality of media based on the first selection. Content of each media may include at least one example of the at least one literary concept. The processor(s) may be configured to receive a second selection including at least one media of the plurality of media. The processor(s) may be configured to generate a lesson plan including the at least one media based on the second selection.

Yet another aspect of the present disclosure relates to a non-transient computer-readable storage medium having instructions embodied thereon, the instructions being executable by one or more processors to perform a method for teaching literary concepts. The method may include generating a first list including a plurality of literary concepts. The method may include receiving a first selection including at least one literary concept of the plurality of literary concepts. The method may include generating a second list including a plurality of media based on the first selection. Content of each media may include at least one example of the at least one literary concept. The method may include receiving a second selection including at least one media of the plurality of media. The method may include generating a lesson plan including the at least one media based on the second selection.

Still another aspect of the present disclosure relates to a system configured for teaching literary concepts. The system may include means for generating a first list including a plurality of literary concepts. The system may include means for receiving a first selection including at least one literary concept of the plurality of literary concepts. The system may include means for generating a second list including a plurality of media based on the first selection. Content of each media may include at least one example of the at least one literary concept. The system may include means for receiving a second selection including at least one media of the plurality of media. The system may include means for generating a lesson plan including the at least one media based on the second selection.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a view of an exemplary lesson bank interface with a plurality of discrete lesson plans, according to certain aspects of the present disclosure.

FIG. 2 illustrates a view of an exemplary lesson builder interface with which a user may select literary concepts for a new lesson plan, according to certain aspects of the present disclosure.

FIG. 3 illustrates a view of an exemplary lesson builder interface with which a user may select a theme for a new lesson plan, according to certain aspects of the present disclosure.

FIG. 4 illustrates a view of an exemplary lesson builder interface with which a user may select a source text for a new lesson plan, according to certain aspects of the present disclosure.

FIG. 5 illustrates a view of an exemplary lesson builder interface with which a user may review a draft lesson plan, according to certain aspects of the present disclosure.

FIG. 6 illustrates a view of an exemplary lesson plan, according to certain aspects of the present disclosure.

FIG. 7 illustrates a view of an exemplary lesson plan with guided listening, according to certain aspects of the present disclosure.

FIG. 8 illustrates a system configured for teaching literary concepts, according to certain aspects of the disclosure.

FIG. 9 illustrates an example flow diagram for teaching literary concepts, according to certain aspects of the disclosure.

FIG. 10 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

By many measures, literacy in the US is in decline. For example, average scores on the NAEP reading assessment have been trending down for the past six years. One explanation may be a disconnect between students' learning styles and preferences and traditional teaching methods for literacy.

The subject disclosure provides for systems and methods for teaching literary concepts. A user (e.g., a teacher) is allowed to select from automatically curated content to create a customized lesson plan to teach a literary concept. For example, the curated content may include songs, song lyrics, movies, movie scripts, and/or other mainstream content that embodies the literary concept to reinforce engagement and learning among today's youth.

Implementations described herein address these and other shortcomings by allowing teachers (or other users) to create customized lesson plans to teach literary concepts. In exemplary implementations, the customized lesson plans may include slides with text and media describing one or more literary concepts. The literary concept(s) may be associated with a pairing between a literary “anchor” text (e.g., a classic poem or novel) and a contemporary recording artist, to whom many young students are likely familiar. The anchor text and the lyrics of a song by the recording artist may reinforce the literary concept(s) being taught in a way that makes learning more engaging and effective for today's youth.

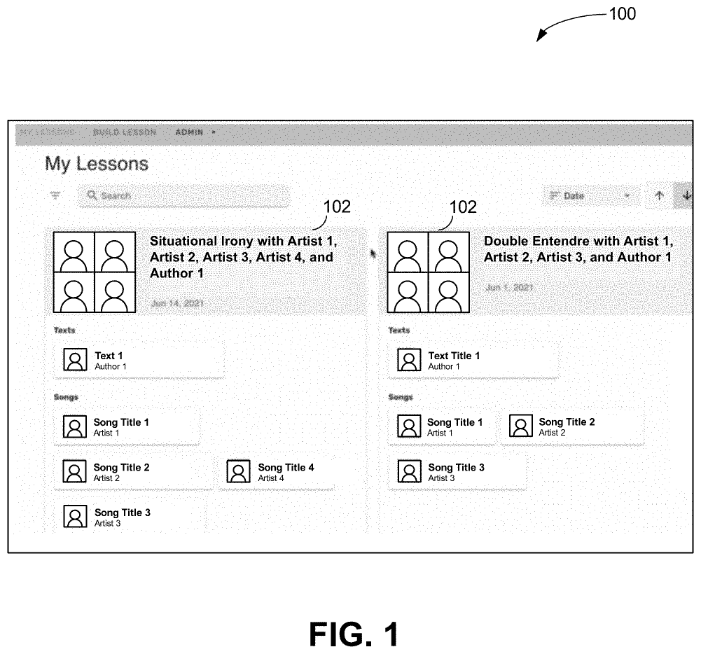

FIG. 1 illustrates a view 100 of an exemplary lesson bank interface with a plurality of discrete lesson plans 102, according to certain aspects of the present disclosure. In some implementations, individual ones of the lesson plans 102 are auto-generated based on user inputs and/or other information. Each lesson plan 102 may be associated with one or more literary concepts (e.g., alliteration, imagery, juxtaposition, simile, etc.). In some implementations, a literary concept may be paired in each lesson plan 102 with a recording artist. In doing so, song lyrics may be used to teach literacy competencies.

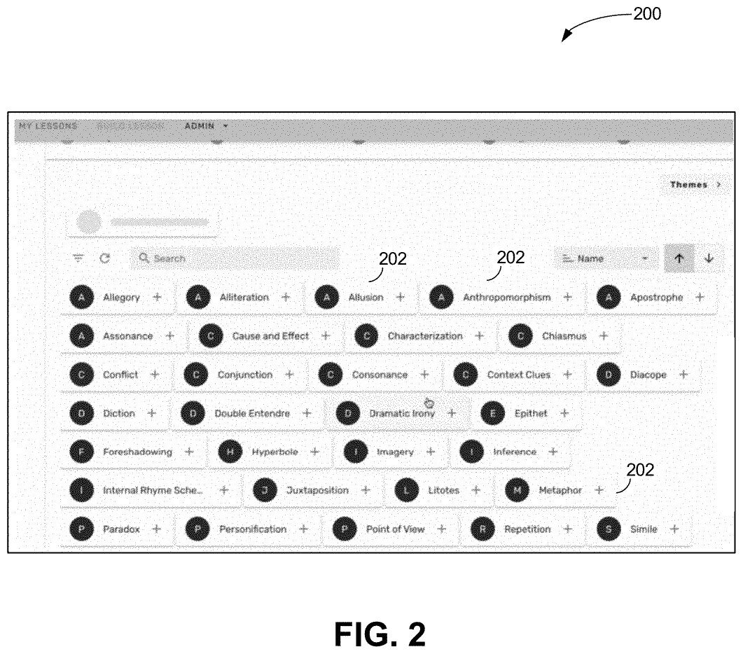

FIG. 2 illustrates a view 200 of an exemplary lesson builder interface with which a user may select literary concepts 202 for a new lesson plan, according to certain aspects of the present disclosure. Literary concepts may include some of the things that English, history, or civics teachers might teach in grade school. The new lesson plan, through its associated literary concept(s) and content, may focus on a topic being taught to students. A user may click on one or more of the literary concepts 202 so they are included in the lesson plan being built.

In some implementations, state standards (e.g., per grade level) may be presented to the user. The state standards may include definitions of literary concepts. Having access to the state standards may aid the user in ensuring a particular literary concept supports a desired teaching objective. The state standards may include or be adapted from the Common Core State Standards (CCSS).

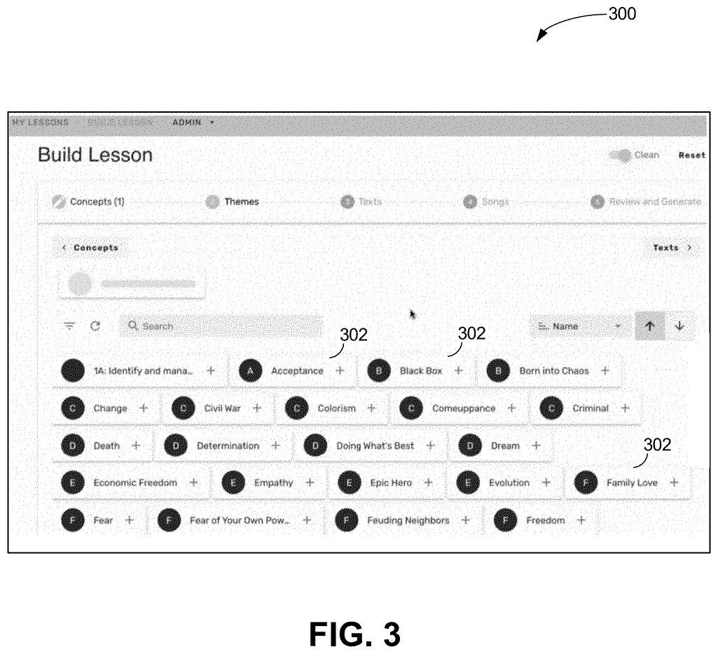

FIG. 3 illustrates a view 300 of an exemplary lesson builder interface with which a user may select a theme 302 for a new lesson plan, according to certain aspects of the present disclosure. For example, some teachers like to teach classes or units based on a theme. If a teacher is teaching a class or unit on a specific or broad topic (e.g., the Civil War, World War II, unrequited law, capitalism, etc.), that topic could be the basis for choosing a certain theme 302 for the new lesson plan.

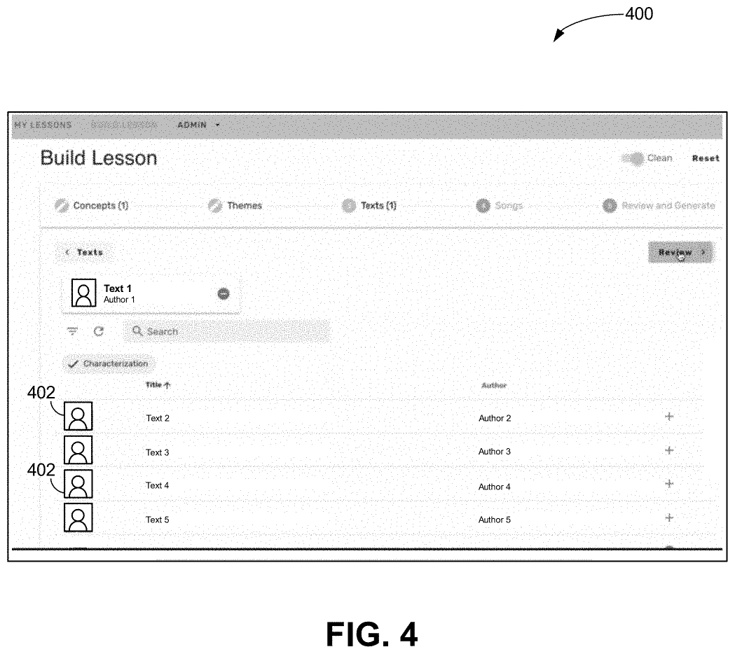

FIG. 4 illustrates a view 400 of an exemplary lesson builder interface with which a user may select an anchor text 402 for a new lesson plan, according to certain aspects of the present disclosure. A given anchor text 402 may include the actual books, the poems, the essays, etc. that a teacher might assign for reading to students. A given anchor text 402 may be included in a teacher's syllabus. The anchor texts 402 from which the user may select from may have been automatically curated based on one or more of the selected literary concept(s) (e.g., literary concepts 202), the selected theme(s) (e.g., themes 302), and/or other information.

In exemplary implementations, a plurality of media may be determined based on one or more of the selected literary concept(s) (e.g., literary concepts 202), the selected theme(s) (e.g., themes 302), the selected anchor text(s) (e.g., anchor texts 402), and/or other information. For example, songs may be identified that illustrate a specific literary concept and those songs may be presented to a user who can select one or more of the songs to include in the lesson plan. In some implementations, a cultural profile of a class of students may be a further basis for determining the plurality of media. For example, the cultural profile may be a basis in determining musical interests of students.

In some implementations, the plurality of media may be determined from a database using an algorithm and/or machine learning. In some implementations, such a database may have been hand-tagged or automatically tagged with characterizations of individual songs. In some implementations, individual words and/or phrases in song lyrics may be tagged such that the lyrics can be readily correlated with literary concepts, themes, etc.

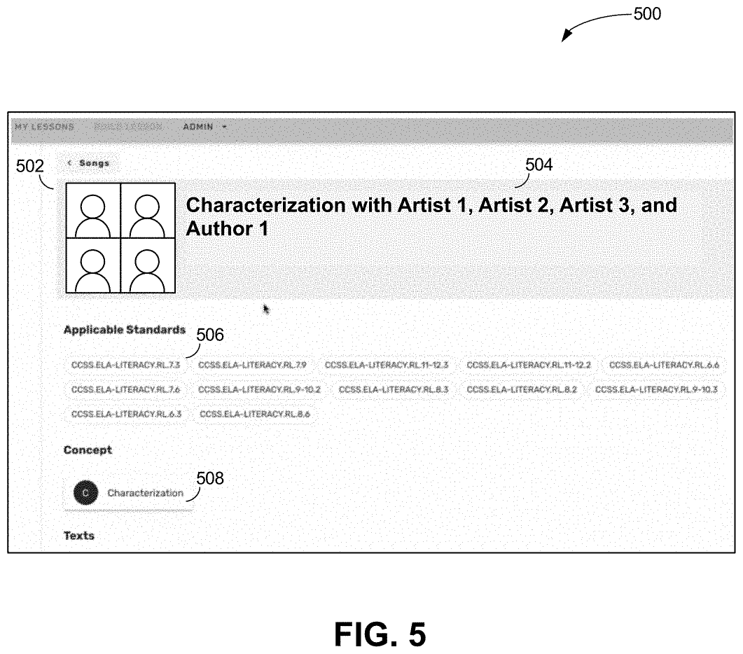

FIG. 5 illustrates a view 500 of an exemplary lesson builder interface with which a user may review a draft lesson plan 502, according to certain aspects of the present disclosure. The draft lesson plan 502 may include one or more or a title 504, applicable standards 506, a literary concept 508, and/or other information. The draft lesson plan 502 may include an excerpt of an anchor text (e.g., anchor text 402), which demonstrates literary concept 508. The draft lesson plan 502 may be configured to facilitate viewing media (e.g., a music video). In some implementations, the draft lesson plan 502 may allow a user to “clean up” lyrics by removing and/or modifying offensive words and/or phrases.

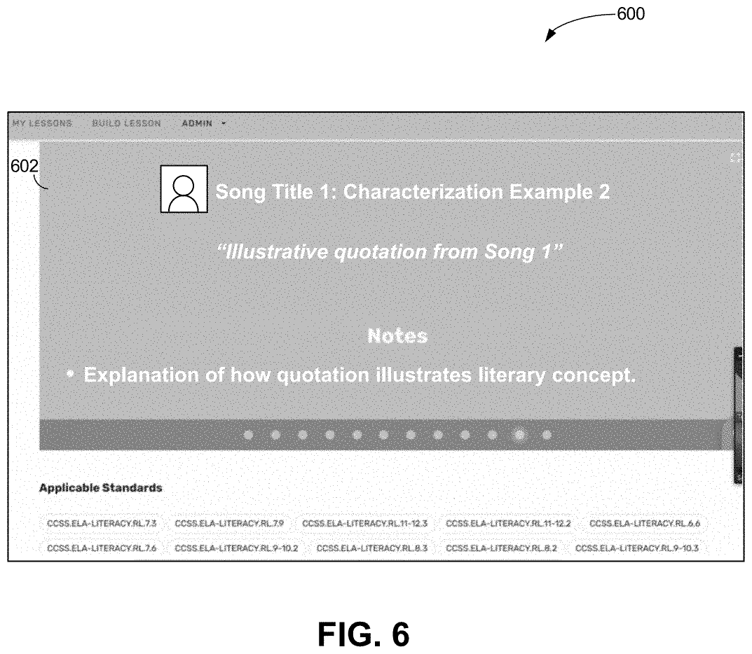

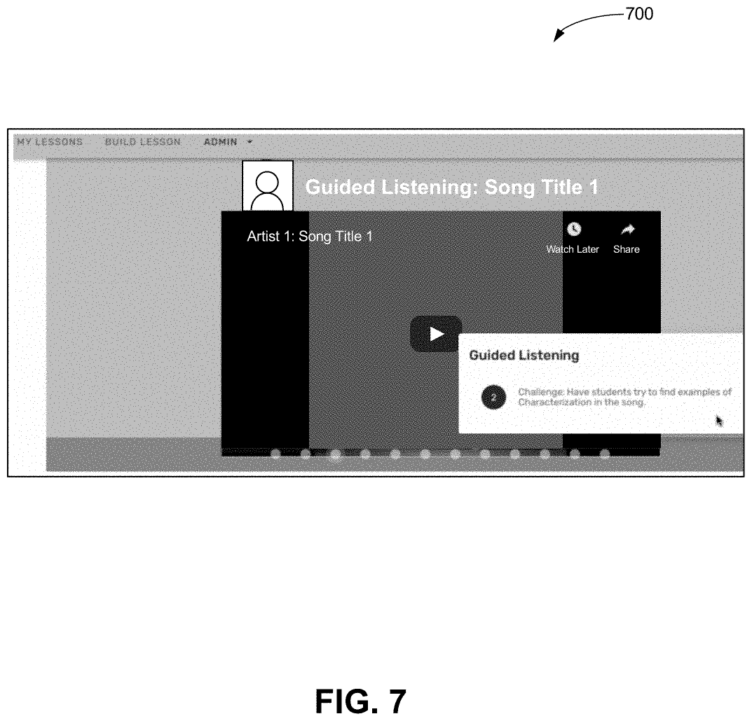

FIG. 6 illustrates a view 600 of an exemplary lesson plan 602, according to certain aspects of the present disclosure. The lesson plan 602 may include auto-generated slides (e.g., presentation slide deck) useful for teaching a literary concept (e.g., literary concept 508). The lesson plan 602 may include a playlist having media (e.g., music, videos, etc.) which students can view and/or listen to. According to various implementations, the playlist may include any number of media (e.g., one, two, three, four, five or more, ten or more, etc.). The playlist may include guiding questions so that students can answer certain questions as they view and/or listen to media. The guiding questions are described further in connection with FIG. 7. The lesson plan 602 includes excerpts of all content included in the lesson plan 602 (e.g., excepts from an anchor text, media such as song lyrics, standards descriptions, literary concept definitions, etc.). Questions for students may be associated with individual excerpts.

In some implementations, the lesson plan 602 may include a set of quizzes, activities, handouts, and/or assessments based on the relevant standards. The set of quizzes, activities, handouts, and/or assessments may be auto-generated based on user inputs received via the lesson builder interface (e.g., as described in connection with FIGS. 2-5). The set of quizzes, activities, handouts, and/or assessments may be saved to a user account and/or may be exportable as a presentation file (e.g., PowerPoint, Google Slides, etc.), portable document file, and/or other formats. The set of quizzes, activities, and/or assessments may be based on predefined templates that are customized for individual lesson plans. Different types of literary concepts may be associated with different templates.

FIG. 7 illustrates a view of an exemplary lesson plan 700 with guided listening, according to certain aspects of the present disclosure. In some implementations, questions for students may be presented incrementally while music is played or accessed via lesson plan 700. In some implementations, questions for students may be presented in sync with lyrics in music being played or accessed via lesson plan 700.

According to some implementations, certifications may be generated for students that complete a lesson plan and/or a course. Some implementations may include a survey asking for student feedback on a lesson plan.

The disclosed system(s) address a problem in traditional teaching literary concepts techniques tied to computer technology, namely, the technical problem of creating lesson plans for teaching literary concepts such that the lesson plans include relatable materials for today's students. The disclosed system solves this technical problem by providing a solution also rooted in computer technology, namely, by providing for teaching literary concepts. The disclosed subject technology further provides improvements to the functioning of the computer itself because it improves processing and efficiency in teaching literary concepts.

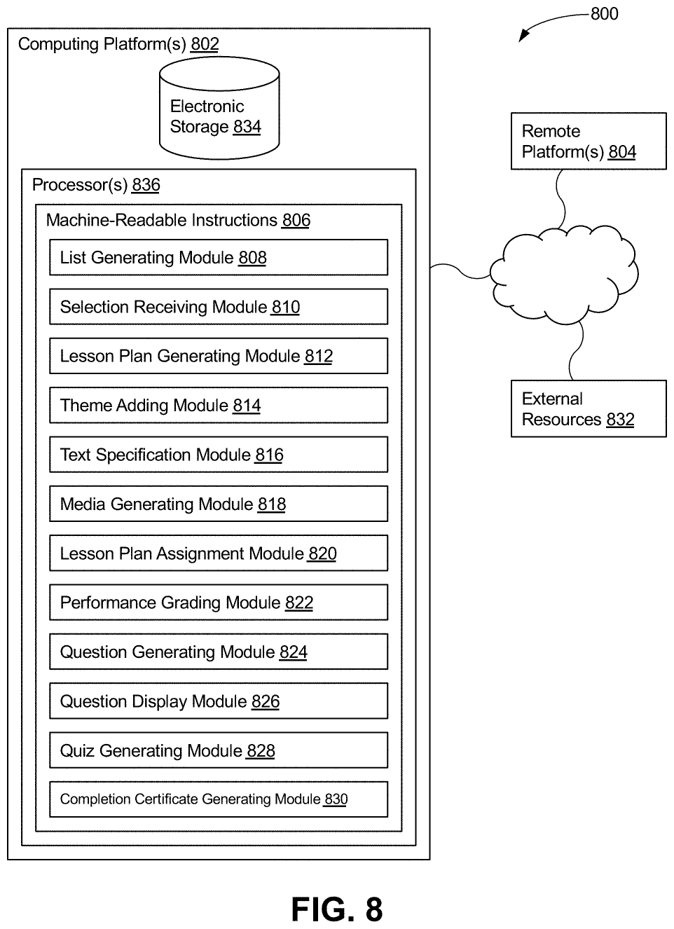

FIG. 8 illustrates a system 800 configured for teaching literary concepts, according to certain aspects of the disclosure. In some implementations, system 800 may include one or more computing platforms 802. Computing platform(s) 802 may be configured to communicate with one or more remote platforms 804 according to a client/server architecture, a peer-to-peer architecture, and/or other architectures. Remote platform(s) 804 may be configured to communicate with other remote platforms via computing platform(s) 802 and/or according to a client/server architecture, a peer-to-peer architecture, and/or other architectures. Users may access system 800 via remote platform(s) 804.

Computing platform(s) 802 may be configured by machine-readable instructions 806. Machine-readable instructions 806 may include one or more instruction modules. The instruction modules may include computer program modules. The instruction modules may include one or more of list generating module 808, selection receiving module 810, lesson plan generating module 812, theme adding module 814, text specification module 816, media generating module 818, lesson plan assignment module 820, performance grading module 822, question generating module 824, question display module 826, quiz generating module 828, completion certificate generating module 830, and/or other instruction modules.

List generating module 808 may be configured to generate a first list including a plurality of literary concepts. In some implementations, by way of non-limiting example, a given literary concept may include one or more of allegory, alliteration, allusion, anthropomorphism, apostrophe, assonance, cause and effect, characterization, chiasmus, conflict, conjunction, consonance, context clues, diacope, diction, double entendre, dramatic irony, epithet, foreshadowing, hyperbole, imagery, inference, internal rhyme scheme, juxtaposition, litotes, metaphor, paradox, personification, point of view, repetition, or simile.

List generating module 808 may be configured to generate a second list including a plurality of media based on the first selection. The second list may include generic thumbnail pictures of artists associated with each media. Content of each media may include at least one example of a literary concept.

Selection receiving module 810 may be configured to receive a first selection including at least one literary concept of the plurality of literary concepts. In some implementations, each literary concept may be associated with a standard of competence. In some implementations, the standard of competence may include a description of a level of mastery of a specific literary concept. In some implementations, the standard of competence was defined by a government agency. In some implementations, the standard of competence may be associated with a grade level.

Selection receiving module 810 may be configured to receive a second selection including at least one media of the plurality of media. By way of non-limiting example, the media may include one or more of music, speeches, or videos.

Lesson plan generating module 812 may be configured to generate a lesson plan including the at least one media based on the second selection. The lesson plan may be used, for example, by a teaching in teaching a literary concept to a class of students. Exemplary implementations of lesson plans are further described in connection with FIGS. 1-7.

Theme adding module 814 may be configured to add a theme to the lesson plan. The at least one media of the lesson plan may include a first media and a second media. The theme may include related subject matter in both the first media and the second media. The theme may be user-selected. In some implementations, each literary concept may include a theme. By way of non-limiting example, the theme may include one or more of acceptance, black box, born into chaos, change, civil war, colorism, comeuppance, criminal, death, determination, doing what's best, dream, economic freedom, empathy, epic hero, evolution, family love, fear, fear of your own power, feuding neighbors, or freedom.

Text specification module 816 may be configured to specify an anchor text for the lesson plan. The anchor text may include a famous or noteworthy literary work. The anchor text may be included in a syllabus associated with a group of students. The anchor text may be user-selected. By way of non-limiting example, the anchor text may include one or more of a speech, a book, a poem, or an article.

Media generating module 818 may be configured to generate excerpts based on the at least one media. The excerpts may include explanations of the at least one literary concept. Individual ones of the explanations may include one or both of a narrative description of a literary concept or examples of literary concepts. Individual ones of the explanations may include one or both of a narrative description of a literary concept or examples of literary concepts. In some implementations, by way of non-limiting example, generating a given excerpt may include extracting the given excerpt from one or more of a database storing explanations of literary concepts, a literary corpus, or literary references. In some implementations, by way of non-limiting example, generating a given excerpt may include extracting the given excerpt from one or more of a database storing explanations of literary concepts, a literary corpus, or literary references.

Media generating module 818 may be configured to generate transcripts for each media. Machine learning may be utilized to generate the transcripts. The transcripts may highlight literary concepts demonstrated by each media.

Lesson plan assignment module 820 may be configured to assign the lesson plan to a group of students. Assigning the lesson plan may include receiving one or more user selections associated with the lesson plan. The group of students may include a class of students at a school.

Performance grading module 822 may be configured to grade performance of the students in regards to the lesson plan. In some implementations, grading performance of a first student may include obtaining a score associated with how well the first student understands a specific literary concept. Grading performance of a first student may include automatically assessing interactions between the first student and the lesson plan. In some implementations, the score may be a weighted based grade. In some implementations, the score may be anonymized. The score may be aggregated with scores associated with students in the group of students.

Question generating module 824 may be configured to generate a plurality of timed questions relating to the at least one literary concept. In some implementations, a timing of the plurality of timed questions may correspond to occurrences of examples of a literary concept in audio or video being played. Question display module 826 may be configured to display the plurality of timed questions as pop-up questions during viewing of the lesson plan. Quiz generating module 828 may be configured to generate a quiz based on the lesson plan. The quiz may include questions related to the at least one literary concept.

Completion certificate generating module 830 may be configured to generate a completion certificate upon completion of the lesson plan. A completion certificate may be used to provide evidence that a student completed a specific lesson plan and/or breached a threshold score on a quiz associated with the specific lesson plan.

In some implementations, computing platform(s) 802, remote platform(s) 804, and/or external resources 832 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 802, remote platform(s) 804, and/or external resources 832 may be operatively linked via some other communication media.

A given remote platform 804 may include one or more processors configured to execute computer program modules. The computer program modules may be configured to enable an expert or user associated with the given remote platform 804 to interface with system 800 and/or external resources 832, and/or provide other functionality attributed herein to remote platform(s) 804. By way of non-limiting example, a given remote platform 804 and/or a given computing platform 802 may include one or more of a server, a desktop computer, a laptop computer, a handheld computer, a tablet computing platform, a NetBook, a Smartphone, a gaming console, and/or other computing platforms.

External resources 832 may include sources of information outside of system 800, external entities participating with system 800, and/or other resources. In some implementations, some or all of the functionality attributed herein to external resources 832 may be provided by resources included in system 800.

Computing platform(s) 802 may include electronic storage 834, one or more processors 836, and/or other components. Computing platform(s) 802 may include communication lines, or ports to enable the exchange of information with a network and/or other computing platforms. Illustration of computing platform(s) 802 in FIG. 8 is not intended to be limiting. Computing platform(s) 802 may include a plurality of hardware, software, and/or firmware components operating together to provide the functionality attributed herein to computing platform(s) 802. For example, computing platform(s) 802 may be implemented by a cloud of computing platforms operating together as computing platform(s) 802.

Electronic storage 834 may comprise non-transitory storage media that electronically stores information. The electronic storage media of electronic storage 834 may include one or both of system storage that is provided integrally (i.e., substantially non-removable) with computing platform(s) 802 and/or removable storage that is removably connectable to computing platform(s) 802 via, for example, a port (e.g., a USB port, a firewire port, etc.) or a drive (e.g., a disk drive, etc.). Electronic storage 834 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 834 may include one or more virtual storage resources (e.g., cloud storage, a virtual private network, and/or other virtual storage resources). Electronic storage 834 may store software algorithms, information determined by processor(s) 836, information received from computing platform(s) 802, information received from remote platform(s) 804, and/or other information that enables computing platform(s) 802 to function as described herein.

Processor(s) 836 may be configured to provide information processing capabilities in computing platform(s) 802. As such, processor(s) 836 may include one or more of a digital processor, an analog processor, a digital circuit designed to process information, an analog circuit designed to process information, a state machine, and/or other mechanisms for electronically processing information. Although processor(s) 836 is shown in FIG. 8 as a single entity, this is for illustrative purposes only. In some implementations, processor(s) 836 may include a plurality of processing units. These processing units may be physically located within the same device, or processor(s) 836 may represent processing functionality of a plurality of devices operating in coordination. Processor(s) 836 may be configured to execute modules 808, 810, 812, 814, 816, 818, 820, 822, 824, 826, 828, and/or 830, and/or other modules. Processor(s) 836 may be configured to execute modules 808, 810, 812, 814, 816, 818, 820, 822, 824, 826, 828, and/or 830, and/or other modules by software, hardware, firmware, some combination of software, hardware, and/or firmware, and/or other mechanisms for configuring processing capabilities on processor(s) 836. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 808, 810, 812, 814, 816, 818, 820, 822, 824, 826, 828, and/or 830 are illustrated in FIG. 8 as being implemented within a single processing unit, in implementations in which processor(s) 836 includes multiple processing units, one or more of modules 808, 810, 812, 814, 816, 818, 820, 822, 824, 826, 828, and/or 830 may be implemented remotely from the other modules. The description of the functionality provided by the different modules 808, 810, 812, 814, 816, 818, 820, 822, 824, 826, 828, and/or 830 described below is for illustrative purposes, and is not intended to be limiting, as any of modules 808, 810, 812, 814, 816, 818, 820, 822, 824, 826, 828, and/or 830 may provide more or less functionality than is described. For example, one or more of modules 808, 810, 812, 814, 816, 818, 820, 822, 824, 826, 828, and/or 830 may be eliminated, and some or all of its functionality may be provided by other ones of modules 808, 810, 812, 814, 816, 818, 820, 822, 824, 826, 828, and/or 830. As another example, processor(s) 836 may be configured to execute one or more additional modules that may perform some or all of the functionality attributed below to one of modules 808, 810, 812, 814, 816, 818, 820, 822, 824, 826, 828, and/or 830.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

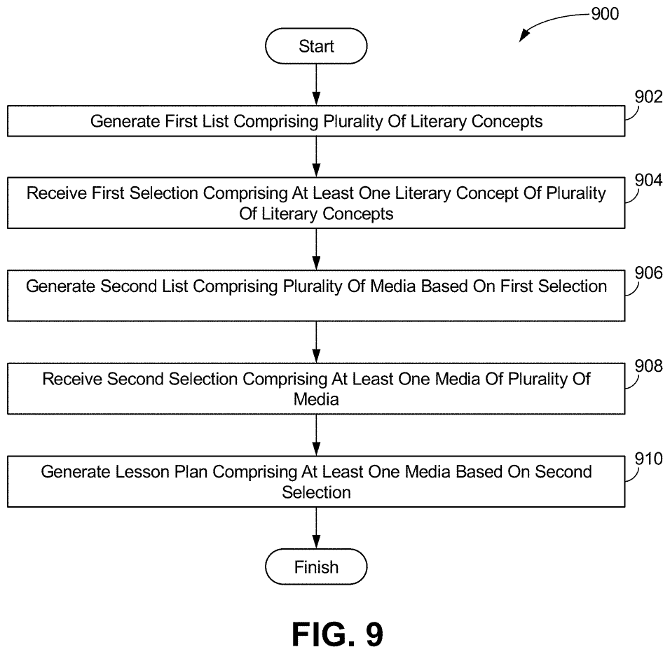

FIG. 9 illustrates an example flow diagram (e.g., process 900) for teaching literary concepts, according to certain aspects of the disclosure. For explanatory purposes, the example process 900 is described herein with reference to FIGS. 1-8. Further for explanatory purposes, the steps of the example process 900 are described herein as occurring in serial, or linearly. However, multiple instances of the example process 900 may occur in parallel. For purposes of explanation of the subject technology, the process 900 will be discussed in reference to FIGS. 1-8.

At step 902, the process 900 may include generating a first list including a plurality of literary concepts. At step 904, the process 900 may include receiving a first selection including at least one literary concept of the plurality of literary concepts. At step 906, the process 900 may include generating a second list including a plurality of media based on the first selection. Content of each media may include at least one example of the at least one literary concept. At step 908, the process 900 may include receiving a second selection including at least one media of the plurality of media. At step 910, the process 900 may include generating a lesson plan including the at least one media based on the second selection.

For example, as described above in relation to FIGS. 1-8, at step 902, the process 900 may include generating a first list including a plurality of literary concepts, through list generating module 808. At step 904, the process 900 may include receiving a first selection including at least one literary concept of the plurality of literary concepts, through selection receiving module 810. At step 906, the process 900 may include generating a second list including a plurality of media based on the first selection, wherein content of each media may include at least one example of the at least one literary concept, through list generating module 808. At step 908, the process 900 may include receiving a second selection including at least one media of the plurality of media, through selection receiving module 810. At step 910, the process 900 may include generating a lesson plan including the at least one media based on the second selection, through lesson plan generating module 812.

According to an aspect, each literary concept is associated with a standard of competence.

According to an aspect, the standard of competence is associated with a grade level.

According to an aspect, the process 900 further includes adding a theme to the lesson plan.

According to an aspect, the process 900 further includes specifying an anchor text for the lesson plan.

According to an aspect, the media comprises one or more of music, speeches, or videos.

According to an aspect, the process 900 further includes generating excerpts based on the at least one media, the excerpts comprising explanations of the at least one literary concept.

According to an aspect, the process 900 further includes assigning the lesson plan to a group of students.

According to an aspect, the process 900 further includes grading performance of the students in regards to the lesson plan.

According to an aspect, the process 900 further includes generating a plurality of timed questions relating to the at least one literary concept.

According to an aspect, the process 900 further includes displaying the plurality of timed questions as pop-up questions during viewing of the lesson plan.

According to an aspect, the process 900 further includes generating transcripts for each media, the transcripts highlighting literary concepts demonstrated by each media.

According to an aspect, machine learning is utilized to generate the transcripts.

According to an aspect, the process 900 further includes generating a quiz based on the lesson plan, the quiz comprising questions related to the at least one literary concept.

According to an aspect, the process 900 further includes generating a completion certificate upon completion of the lesson plan.

According to an aspect, each literary concept comprises a theme.

According to an aspect, the second list comprises generic thumbnail pictures of artists associated with each media.

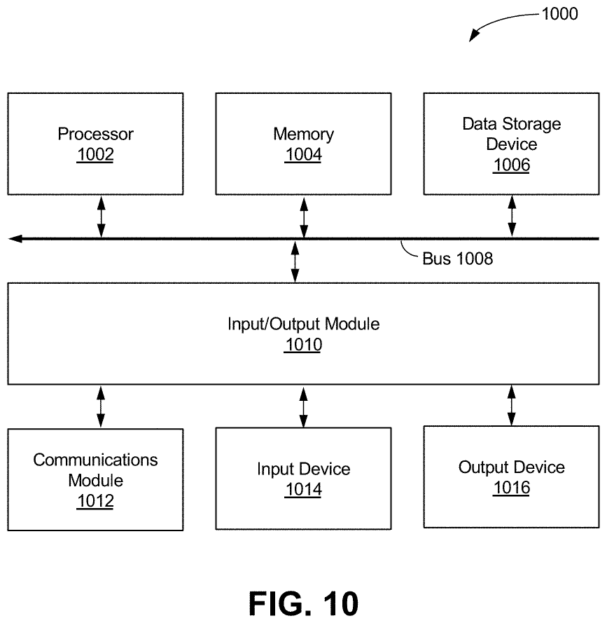

FIG. 10 is a block diagram illustrating an exemplary computer system 1000 with which aspects of the subject technology can be implemented. In certain aspects, the computer system 1000 may be implemented using hardware or a combination of software and hardware, either in a dedicated server, integrated into another entity, or distributed across multiple entities.

Computer system 1000 (e.g., server and/or client) includes a bus 1008 or other communication mechanism for communicating information, and a processor 1002 coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1000 can include, in addition to hardware, code that creates an execution environment for the computer program in question, e.g., code that constitutes processor firmware, a protocol stack, a database management system, an operating system, or a combination of one or more of them stored in an included memory 1004, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, i.e., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1000 further includes a data storage device 1006 such as a magnetic disk or optical disk, coupled to bus 1008 for storing information and instructions. Computer system 1000 may be coupled via input/output module 1010 to various devices. The input/output module 1010 can be any input/output module. Exemplary input/output modules 1010 include data ports such as USB ports. The input/output module 1010 is configured to connect to a communications module 1012. Exemplary communications modules 1012 include networking interface cards, such as Ethernet cards and modems. In certain aspects, the input/output module 1010 is configured to connect to a plurality of devices, such as an input device 1014 and/or an output device 1016. Exemplary input devices 1014 include a keyboard and a pointing device, e.g., a mouse or a trackball, by which a user can provide input to the computer system 1000. Other kinds of input devices 1014 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1016 include display devices such as an LCD (liquid crystal display) monitor, for displaying information to the user.

According to one aspect of the present disclosure, the above-described gaming systems can be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in the main memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1000 can include clients and servers. A client and server are generally remote from each other and typically interact through a communication network. The relationship of client and server arises by virtue of computer programs running on the respective computers and having a client-server relationship to each other. Computer system 1000 can be, for example, and without limitation, a desktop computer, laptop computer, or tablet computer. Computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires that comprise bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1000 reads game data and provides a game, information may be read from the game data and stored in a memory device, such as the memory 1004. Additionally, data from the memory 1004 servers accessed via a network, the bus 1008, or the data storage 1006 may be read and loaded into the memory 1004. Although data is described as being found in the memory 1004, it will be understood that data does not have to be stored in the memory 1004 and may be stored in other memory accessible to the processor 1002 or distributed among several media, such as the data storage 1006.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for teaching literary concepts, comprising:
generating a first list comprising a plurality of literary concepts;
receiving a first selection comprising at least one literary concept of the plurality of literary concepts;
generating a second list comprising a plurality of media based on the first selection, wherein content of each media comprises at least one example of the at least one literary concept;
receiving a second selection comprising at least one media of the plurality of media; and
generating a lesson plan comprising the at least one media based on the second selection.

2. The computer-implemented method of claim 1, wherein each literary concept is associated with a standard of competence.

3. The computer-implemented method of claim 2, wherein the standard of competence is associated with a grade level.

4. The computer-implemented method of claim 1, further comprising:
adding a theme to the lesson plan.

5. The computer-implemented method of claim 1, further comprising:
specifying an anchor text for the lesson plan.

6. The computer-implemented method of claim 1, wherein the media comprises one or more of music, speeches, or videos.

7. The computer-implemented method of claim 1, further comprising:
generating excerpts based on the at least one media, the excerpts comprising explanations of the at least one literary concept.

8. The computer-implemented method of claim 1, further comprising:
assigning the lesson plan to a group of students; and
grading performance of the students in regards to the lesson plan.

9. The computer-implemented method of claim 1, further comprising:
generating a plurality of timed questions relating to the at least one literary concept; and
displaying the plurality of timed questions as pop-up questions during viewing of the lesson plan.

10. The computer-implemented method of claim 1, further comprising:
generating transcripts for each media, the transcripts highlighting literary concepts demonstrated by each media.

11. A system configured for teaching literary concepts, the system comprising:
one or more hardware processors configured by machine-readable instructions to:
generate a first list comprising a plurality of literary concepts;
receive a first selection comprising at least one literary concept of the plurality of literary concepts;
generate a second list comprising a plurality of media based on the first selection, wherein content of each media comprises at least one example of the at least one literary concept;
receive a second selection comprising at least one media of the plurality of media; and
generate a lesson plan comprising the at least one media based on the second selection.

12. The system of claim 11, wherein each literary concept is associated with a standard of competence.

13. The system of claim 12, wherein the standard of competence is associated with a grade level.

14. The system of claim 11, wherein the one or more hardware processors are further configured by machine-readable instructions to:
add a theme to the lesson plan.

15. The system of claim 11, wherein the one or more hardware processors are further configured by machine-readable instructions to:
specify an anchor text for the lesson plan.

16. The system of claim 11, wherein the media comprises one or more of music, speeches, or videos.

17. The system of claim 11, wherein the one or more hardware processors are further configured by machine-readable instructions to:
generate excerpts based on the at least one media, the excerpts comprising explanations of the at least one literary concept.

18. The system of claim 11, wherein the one or more hardware processors are further configured by machine-readable instructions to:
assign the lesson plan to a group of students; and
grade performance of the students in regards to the lesson plan.

19. The system of claim 11, wherein the one or more hardware processors are further configured by machine-readable instructions to:
generate a plurality of timed questions relating to the at least one literary concept;
display the plurality of timed questions as pop-up questions during viewing of the lesson plan; and
generate transcripts for each media, the transcripts highlighting literary concepts demonstrated by each media.

20. A non-transient computer-readable storage medium having instructions embodied thereon, the instructions being executable by one or more processors to perform a method for teaching literary concepts, the method comprising:
generating a first list comprising a plurality of literary concepts;
receiving a first selection comprising at least one literary concept of the plurality of literary concepts;
generating a second list comprising a plurality of media based on the first selection, wherein content of each media comprises at least one example of the at least one literary concept;
receiving a second selection comprising at least one media of the plurality of media; and
generating a lesson plan comprising the at least one media based on the second selection.
